(19) United States
(12) Patent Application Publication
(10) Pub. No.: US 2016/0098962 A1
(43) Pub. Date: Apr. 7, 2016

(54) DISPLAY DEVICE AND DRIVING METHOD THEREOF

(71) Applicant: InnoLux Corporation, Miao-Li County (TW)

(72) Inventor: Minoru SHIBAZAKI, Miao-Li County (TW)

(21) Appl. No.: 14/508,319

(22) Filed: Oct. 7, 2014

(51) Int. Cl. G09G 3/34

(52) U.S. Cl. CPC G09G 3/3406; G09G 2330/021; G09G 2310/04

(57) ABSTRACT

A driving method is applied to a display device including a display panel, a backlight module, and a processing circuit. The processing circuit is coupled to the display panel and the backlight module. The driving method includes the following steps of when the image is a still image, enabling the processing circuit to control the display panel to display the image during a first frame time, and to control the backlight module to blink in accordance with a first driving frequency during the first frame time.

### BACKGROUND

1. Technical Field

The present invention relates to a display device and a driving method thereof.

2. Related Art

As the progressive of technologies, many novel and powerful information devices have been developed. The novel electronic devices, such as cell phones, tablet computers, UMPC and GPS, are portable and have powerful and various functions, so they can make our lives more convenient and have been widely spread.

In general, the display panel of an electronic device usually has a refresh rate of 60-75 Hz for maintaining the smoothness of the displayed image. However, when displaying a still image such as a picture, figure, text information or web page, the display panel can properly show the still image with a lower refresh rate. Accordingly, if the refresh rate of the display panel is kept at 60-75 Hz, it will cause unnecessary power consumption. Therefore, it is an important subject to provide a display device and a driving method thereof that can decrease the power consumption and still remain the display performance.

### SUMMARY

In view of the foregoing subject, an objective of the present invention is to provide a display device and a driving method thereof that can decrease the power consumption and still remain the display performance.

To achieve the above objective, the present invention discloses a driving method applied to a display device. The display device includes a display panel, a backlight module and a processing circuit coupling to the display panel and the backlight module. The driving method includes the following step of: when the image is a still image, enabling the processing circuit to control the display panel to display the image during a first frame time, and to control the backlight module to blink in accordance with a first driving frequency during the first frame time.

To achieve the above objective, the present invention also discloses a display device including a display panel, a backlight module and a processing circuit. The backlight module is disposed opposite to the display panel, and the processing circuit couples to the display panel and the backlight module. When the image is a still image, the processing circuit controls the display panel to display the image during a first frame time, and controls the backlight module to blink in accordance with a first driving frequency during the first frame time.

In one embodiment, when the image is not a still image, the processing circuit controls the display panel to display the image during a second frame time. Herein, the second frame time is shorter than the first frame time.

In one embodiment, when the image is not a still image, the processing circuit controls the backlight module to blink in accordance with a second driving frequency during a second frame time or to keep turning on during the second frame time. Herein, the second driving frequency is less than or equal to the first driving frequency.

In one embodiment, the driving method further includes a step of: enabling the processing circuit to control the backlight module to blink in accordance with the first driving frequency during a part of the first frame time and then to control the backlight module to keep turning on.

In one embodiment, the backlight module has a first brightness as it blinks, and the backlight module has a second brightness as it keeps turning on.

In one embodiment, the first frame time corresponds to a first refresh rate being smaller than 60 Hz, and the second frame time corresponds to a second refresh rate being greater than or equal to 60 Hz.

In one embodiment, the display panel has a plurality of liquid crystal cells, and a polarity change rate of the liquid crystal cells is smaller than or equal to the first refresh rate.

In one embodiment, the first frame time includes an image writing period and a waiting period, and the image writing period is in front of the waiting period.

In one embodiment, the backlight module blinks in accordance with the first driving frequency during the image writing period, and keeps turning on during the waiting period until the end of the first frame time.

As mentioned above, in the display device and the driving method thereof, when the image is a still image, the display panel displays the image with a longer frame time (the first frame time). This configuration can decrease the refresh rate of the display panel as displaying the still image, and thus reduce the total power consumption. At the same time, the backlight module blinks in accordance with a first driving frequency. Compared with the conventional art that needs to continuously turn on the backlight module, the backlight module of this invention can save a certain energy. Besides, this invention can further minimize the flicker phenomena as the display panel displays images, thereby improving the display performance of the display device.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1A is a flow chart of a driving method of a display device according to a first embodiment of the invention;

FIG. 1B is a function block diagram of a display device according to the first embodiment of the invention;

FIGS. 2A and 2B are schematic diagrams showing two aspects of the timing chart for the backlight module of FIG. 1B during a first frame time;

FIG. 2C is a schematic diagram showing another aspect of the timing chart for the backlight module of FIG. 1B during a second frame time;

FIG. 3A is a function block diagram of a display device according to a second embodiment of the invention;

FIG. 3B is a schematic diagram showing an aspect of the timing chart for the backlight module of FIG. 3A during a second frame time; and

FIGS. 4A, 4B and 4C are schematic diagrams showing different aspects of the polarity change of the liquid crystal cell of the display panel.

### DETAILED DESCRIPTION OF THE INVENTION

The embodiments of the invention will be apparent from the following detailed description, which proceeds with reference to the accompanying drawings, wherein the same references relate to the same elements.

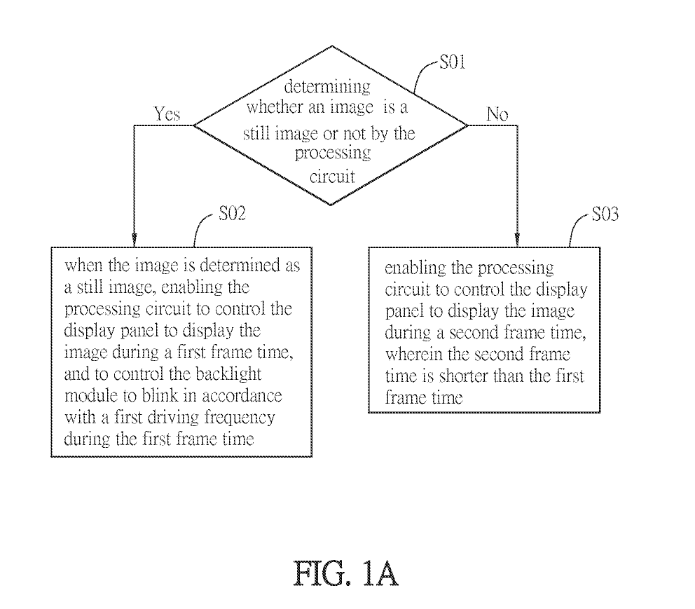

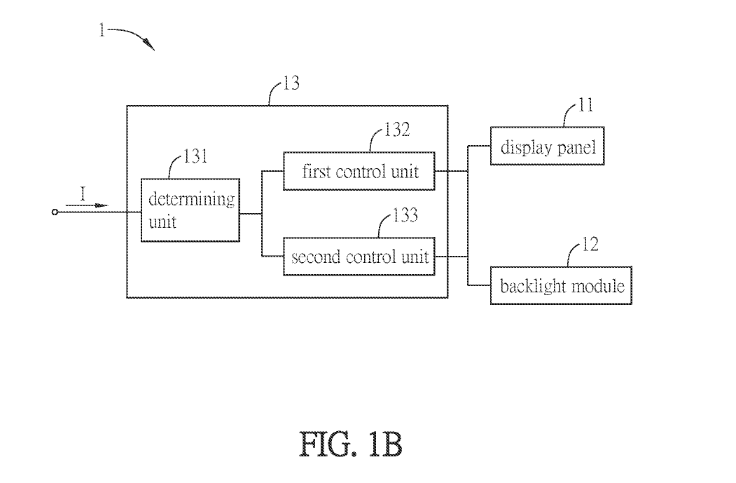

FIG. 1A is a flow chart of a driving method of a display device according to a first embodiment of the invention, and FIG. 1B is a function block diagram of a display device 1 according to the first embodiment of the invention. The display panel 1 can be a liquid crystal display device or a liquid crystal touch display device. In this embodiment, the display panel 1 is a liquid crystal display device. Referring to FIGS. 1A and 1B, the display device 1 includes a display panel 11, a backlight module 12 and a processing circuit 13. The backlight module 12 is disposed opposite to the display panel 11, and the processing circuit 13 is coupled to the display panel 11 and the backlight module 12. In this embodiment, the driving method is applied to the display device 1 and includes the following steps of: determining whether an image is a still image or not by the processing circuit (S01); and when the image is determined as a still image, enabling the processing circuit to control the display panel to display the image during a first frame time, and to control the backlight module to blink in accordance with a first driving frequency during the first frame time (S02).

In this embodiment, the processing circuit 13 can be implemented by a digital circuit or an analog circuit. The digital circuit is, for example, an IC such as a micro-processor, a MCU, a FPGA, a CPLD or an ASIC, and this invention is not limited.

The processing circuit 13 can determine whether the image I is a still image or not by analyzing the frame data of the image I. For example, the processing circuit 13 can compare different image frames within a time period. In practice, the processing circuit 13 can compare the pixel data of corresponding positions in the previous displayed image data and the next image data so as to obtain a pixel variation percentage according to the change percentage of the pixel data. The determining step can be performed relying on the obtained pixel variation percentage. When the pixel variation percentage is smaller than a preset value, the processing circuit 13 determines the image I is a still image. Alternatively, the processing circuit 13 can perform a motion detection with respect to the previous displayed image data and the next image data so as to obtain a motion vector, and the determining step can be performed relying on the obtained motion vector. For example, when the motion vector is smaller than a preset value, the processing circuit 13 determines the image I is a still image. In some embodiments, the processing circuit 13 can also determine whether the image I is a still image or not by analyzing the source or format (e.g. GIF, BMP, JPG, MPEG or AVI) of the image I. Of course, the above mentioned analyzing methods are for illustrations only, and this invention is not limited thereto. Any approach that can determine whether the image I is a still image or not is applicable.

In the step S02, when the image I is determined as a still image, the processing circuit 13 is enabled to control the display panel 11 to display the image I during a first frame time, and to control the backlight module 12 to blink in accordance with a first driving frequency during the first frame time. In this embodiment, the first frame time corresponds to a first refresh rate, which is smaller than 60 Hz.

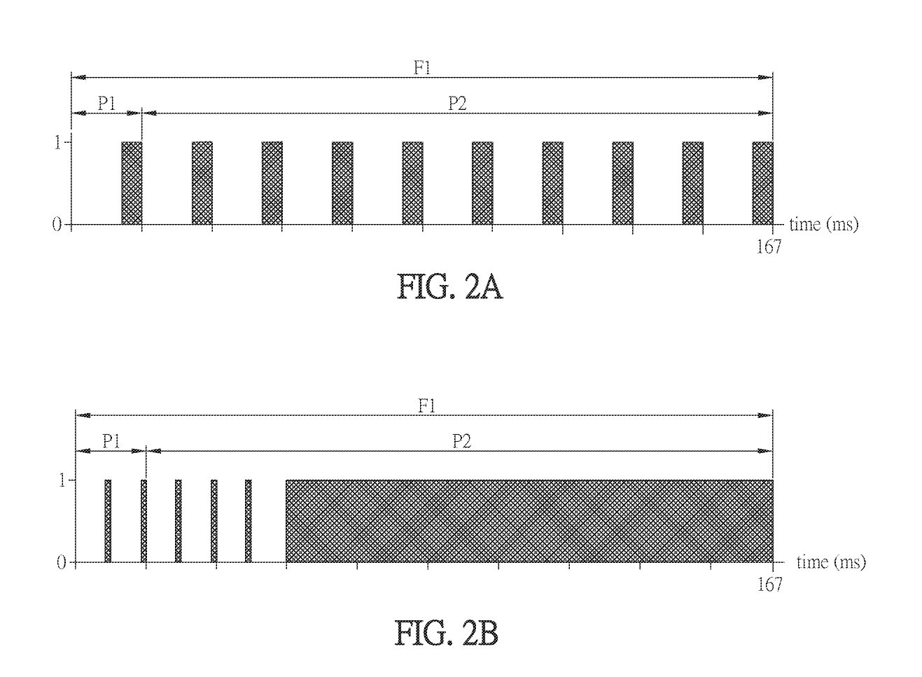

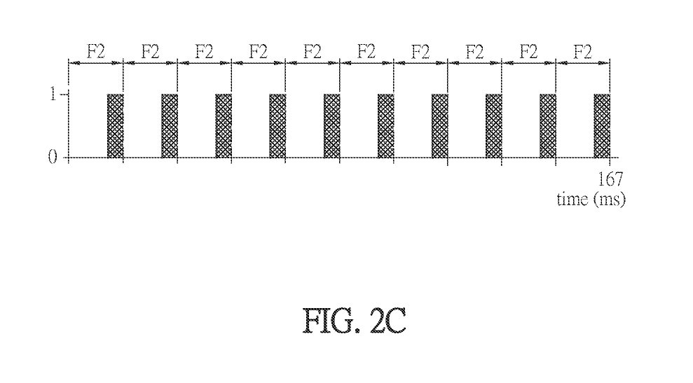

FIG. 2A is a schematic diagram showing an aspect of the timing chart for the backlight module of FIG. 1B during a first frame time. To be noted, the horizontal axis of FIG. 2A represents time, and the vertical axis represents the operation status of the backlight module 12 (wherein, “turn on” is 1, and “turn off” is 0). Herein, the number, order and brightness of the light-emitting units to be turned on as the backlight module is turned on are not further discussed. The backlight module 12 is turned on when the operation status is “1”. Referring to FIGS. 1A and 1B in view of FIG. 2A, when the processing circuit 13 determines that the image I is a still image, the step S02 is performed then. In this embodiment, the first refresh rate of the display panel 11 is 6 Hz, which means the first frame time F1 is about 167 ms. In other words, the interval between two refresh operations is about 167 ms. In this case, the first frame time F1 includes an image writing period P1 and a waiting period P2, and the image writing period P1 is in front of the waiting period P2. The image writing period P1 is the period for turning on the gates of the display panel 11, and the waiting period is the period for turning off the gates of the display panel 11. At the same time, the backlight module 12 blinks in accordance with a first driving frequency. In this embodiment, the first driving frequency is 60 Hz, so that the backlight module 12 is turned on/off every 16.7 ms. In other words, the backlight module 12 blinks (alternately turning on and off) for many times (10 times) during the first frame time F1 of the display device 1. The backlight module 12 turns on for a lasting time and the lasting time ranges from 1 to 10 ms. Accordingly, the still image has a first refresh rate smaller than 60 Hz, which can reduce the power consumption of the display device 1. Besides, since the backlight module 12 blinks in accordance with the first driving frequency, it can save more energy than the conventional backlight module, which is continuously turned on. Moreover, the driving method of this embodiment can further minimize the flicker phenomena as the display panel 11 displays images, thereby improving the display performance of the display device 1.

In practice, according to the product requirement, circuit design or user setup, the brightness of the turned-on backlight module 12 can be the same or different, and this invention is not limited. For example, the backlight module 12 may have alternate high and low brightness, or gradually increasing or decreasing brightness. Besides, the duty cycle for turning on the backlight module 12 may be the same or different. Any configuration that can alternately turn on and off the backlight module 12 to achieve the blink effect is applicable.

FIG. 2B is a schematic diagram showing another aspect of the timing chart for the backlight module 12 of FIG. 1B during a first frame time. Referring to FIGS. 1A, 1B and 2B, the processing circuit 13 controls the backlight module 12 to blink in accordance with the first driving frequency during a part of the first frame time and then controls the backlight module 12 to keep turning on. In this embodiment, the backlight module 12 blinks in accordance with the first driving frequency (e.g. 120 Hz) during the image writing period P1 of the display panel 11, and keeps turning on during the waiting period P2 until the end of the first frame time F1. Accordingly, the backlight module 12 only blinks within the image writing period P1, so it can minimize the flicker phenomena as the display panel 11 displays images, thereby improving the display performance of the display device 1.

In this embodiment, the backlight module 12 still blinks in accordance with the first driving frequency at the starting of the waiting period P2. That is, the blinking period of the backlight module 12 is longer than or equal to the image writing period P1. This longer blinking period is configured for compensating the possible ripple issue of the displayed image. The backlight module 12 turns on for a lasting time and the lasting time ranges from 1 to 10 ms. The display device 1 further includes a memory unit (not shown) coupled to the processing circuit 13. The memory unit stores the writing period information of the image I, so that the processing circuit 13 can control the corresponding blinking period of the backlight module 12 according to the writing period information. Accordingly, the blinking period of the backlight module 12 is longer than or equal to the image writing period P1 so as to provide a better display performance.

In some embodiments, according to the product requirement, circuit design or user setup, the backlight module 12 can have a first brightness as it blinks, and the backlight module 12 can have a second brightness as it keeps turning on. The first brightness can be the same or different from the second brightness. Of course, the configuration of the brightness of the backlight module 12 can be changed, and this invention is not limited.

Referring to FIGS. 1A and 1B, the processing circuit 13 includes a determining unit 131, a first control unit 132 and a second control unit 133. The determining unit 131 couples to the first control unit 132 and the second control unit 133. In the step S01, the determining unit 131 of the processing circuit 13 receives the image I and determines whether the image I is a still image or not. When the determining unit 131 determines the image I is a still image, the first control unit 132 executes the step S02 to control the display panel 11 to display the image I during a first frame time F1, and to control the backlight module 12 to blink in accordance with a first driving frequency during the first frame time F1. Alternatively, when the determining unit 131 determines the image I is not a still image, the second control unit 133 controls the display panel 11 to display the image I during a second frame time F2. That is, the driving method may further include a step S03 of: enabling the processing circuit 13 to control the display panel 11 to display the image I during a second frame time. Herein, the second frame time is shorter than the first frame time.

FIG. 2C is a schematic diagram showing another aspect of the timing chart for the backlight module of FIG. 1B during a second frame time. In the step S03, with reference to FIGS. 1A, 1B and 2C, when the image I is determined as not a still image (e.g. the movie image, game image, web page, or document), the display panel 11 displays the image I during a second frame time F2. Herein, the second frame time F2 is shorter than the first frame time F1. The second frame time F2 corresponds to a second refresh rate, which is between 60 Hz and 120 Hz, for keeping the displayed image more fluent. In this embodiment, the second refresh rate is 60 Hz, so the second frame time is 16.7 ms. The backlight module 12 blinks in accordance with a second driving frequency during a second frame time F2. The second frame time F2 (e.g. 60 Hz) can be shorter than or equal to the first frame time F1. In other words, no matter the image I is a still image or a dynamic image, the backlight module 12 is turned on and turned off in accordance with the driving frequency of 60 Hz, while the refresh rate of the display panel 11 is switched (between the first frame time F1 and the second frame time F2) according to that whether the image I is a still image or not. Of course, the second driving frequency of the backlight module 12 can be smaller than 60 Hz, and this invention is not limited.

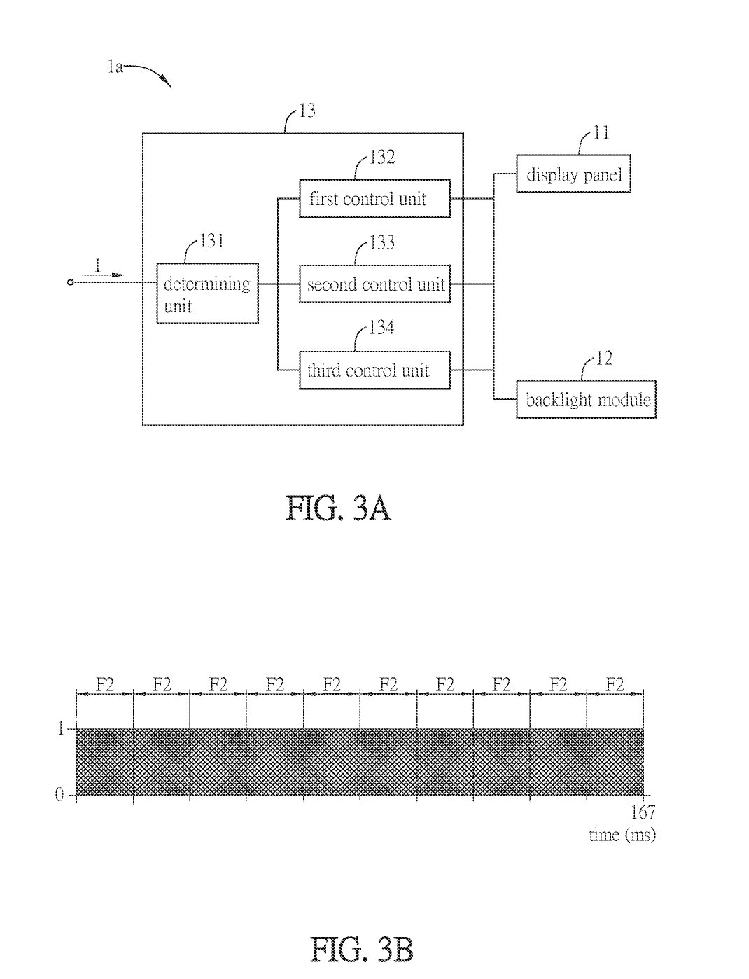

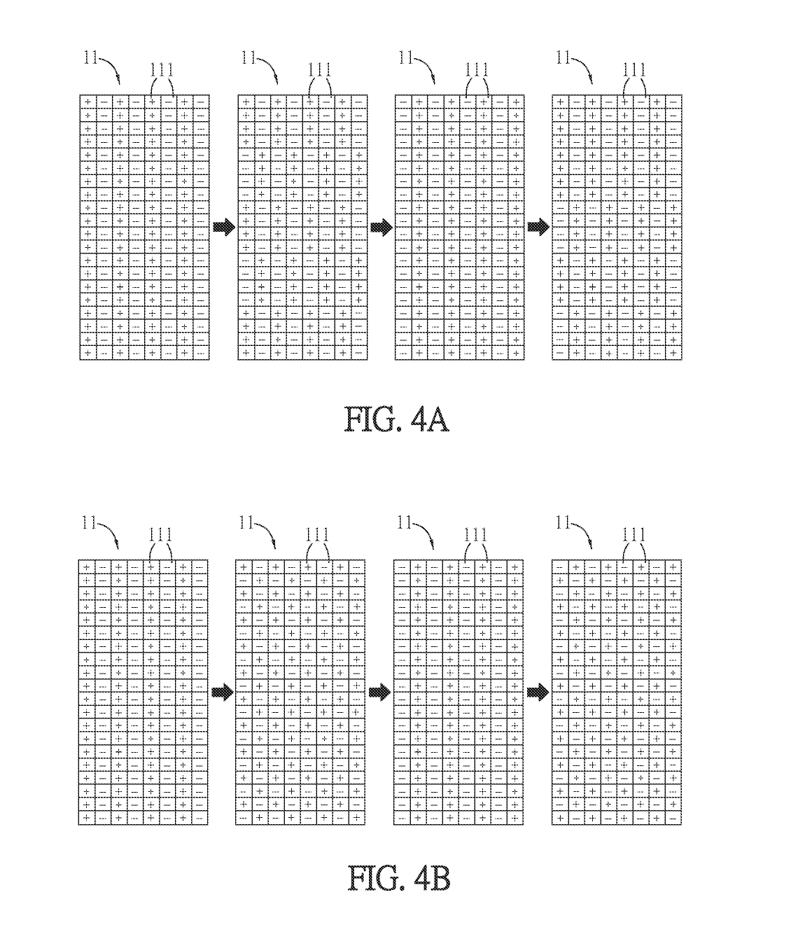

FIG. 3A is a function block diagram of a display device 1a according to a second embodiment of the invention, and FIG. 3B is a schematic diagram showing an aspect of the timing chart for the backlight module 12 of FIG. 3A during a second frame time. Referring to FIGS. 1A, 1B, 3A and 3B, the processing circuit 13 of the display device 1a further includes a third control unit 134, which couples to the determining unit 131, the display panel 11 and the backlight module 12. In some aspects, when the determining unit 131 executes the step S02, it may further determine whether the image I is a high-definition (HD) image such as a game or movie image. When the image I is determined as an HD image, the second control unit 133 of the processing circuit 13 controls the display panel 11 to display the image I during the second frame time F2 and controls the backlight module 12 to blink in accordance with a second driving frequency (as the aspect of FIG. 3A). Otherwise, when the image I is determined as not an HD image (e.g. a web page or document), the third control unit 134 of the processing circuit 13 controls the display panel 11 to display the image I during the second frame time F2 and controls the backlight module 12 to keep turning on during the second frame time F2, which means the backlight module 12 does not blink during the second frame time F2.

To be noted, when the image I is determined as an HD image, the second refresh rate corresponding to the second frame time F2 can be over 60 Hz (e.g. 75 Hz). Otherwise, when the image I is determined as not an HD image, the second refresh rate corresponding to the second frame time F2 can be 60 Hz.

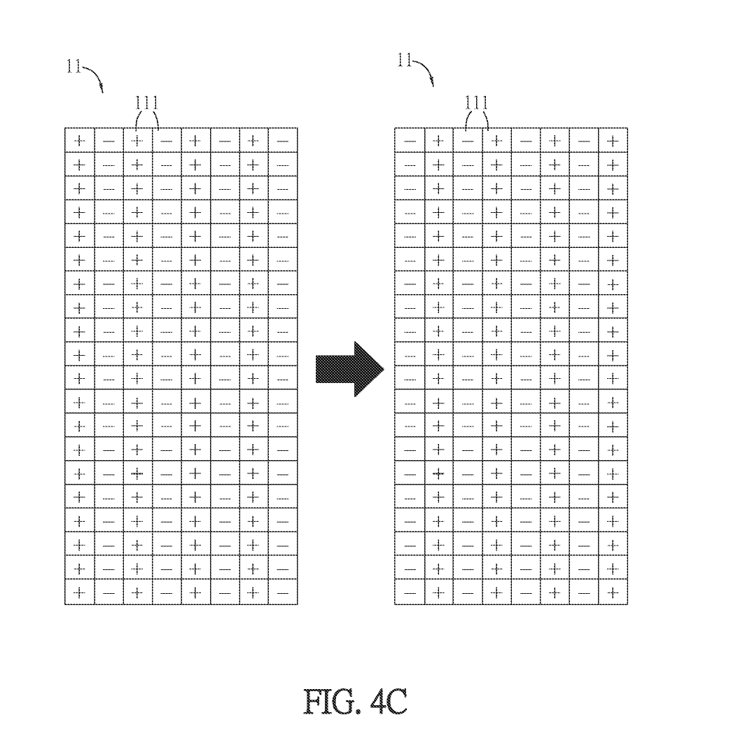

FIGS. 4A, 4B and 4C are schematic diagrams showing different aspects of the polarity change of the liquid crystal cell of the display panel 11. The display panel 11 has a plurality of liquid crystal cells 111, and the polarity change rate of the liquid crystal cells 111 is smaller than or equal to the first refresh rate. As shown in FIGS. 4A and 4B, in this aspect, the polarity of one liquid crystal cell 111 changes every two consequent frame time, and the adjacent liquid crystal cells 111 may have the same or different polarities. In more detailed, only the polarity of a part of the liquid crystal cells 111 (e.g. a half of the liquid crystal cells 111) is changed between two consequent frames. In other words, the polarity change rate of the liquid crystal cells 111 is a half of the frame time. In the aspect of FIG. 4C, each liquid crystal cell 111 can remain in a polarity for a certain of time (e.g. 1 hour or lasting 2 to 1000 frame time), and then changes the polarity. To lower the polarity change rate of the liquid crystal cells 111 can reduce the power consumption.

To sum up, in the display device and the driving method thereof, when the processing circuit determines the image is a still image, the display panel displays the image with a longer frame time (the first frame time). This configuration can decrease the refresh rate of the display panel as displaying the still image, and thus reduce the total power consumption. At the same time, the backlight module blinks in accordance with a first driving frequency. Compared with the conventional art that needs to continuously turn on the backlight module, the backlight module of this invention can save a certain energy. Besides, this invention can further minimize the flicker phenomena as the display panel displays images, thereby improving the display performance of the display device.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A driving method applied to a display device, which comprises a display panel, a backlight module and a processing circuit coupling to the display panel and the backlight module, the driving method comprising a step of:
when the image is a still image, enabling the processing circuit to control the display panel to display the image during a first frame time, and to control the backlight module to blink in accordance with a first driving frequency during the first frame time.

2. The driving method of claim 1, further comprising a step of:
when the image is not a still image, enabling the processing circuit to control the display panel to display the image during a second frame time, wherein the second frame time is shorter than the first frame time.

3. The driving method of claim 1, further comprising a step of:
when the image is not a still image, enabling the processing circuit to control the backlight module to blink in accordance with a second driving frequency during a second frame time or to keep turning on during the second frame time, wherein the second driving frequency is less than or equal to the first driving frequency.

4. The driving method of claim 1, further comprising a step of:
enabling the processing circuit to control the backlight module to blink in accordance with the first driving frequency during a part of the first frame time and then to control the backlight module to keep turning on.

5. The driving method of claim 4, wherein the backlight module has a first brightness as the backlight module blinks, and the backlight module has a second brightness as the backlight module keeps turning on.

6. The driving method of claim 2, wherein the first frame time corresponds to a first refresh rate being smaller than 60 Hz, and the second frame time corresponds to a second refresh rate being greater than or equal to 60 Hz.

7. The driving method of claim 6, wherein the display panel has a plurality of liquid crystal cells, and a polarity change rate of the liquid crystal cells is smaller than or equal to the first refresh rate.

8. The driving method of claim 1, wherein the first frame time includes an image writing period and a waiting period, and the image writing period is in front of the waiting period.

9. The driving method of claim 8, wherein the backlight module blinks in accordance with the first driving frequency during the image writing period, and keeps turning on during the waiting period until the end of the first frame time.

10. A display device, comprising:
a display panel;
a backlight module disposed opposite to the display panel; and
a processing circuit coupling to the display panel and the backlight module;
wherein, when the image is a still image, the processing circuit controls the display panel to display the image during a first frame time, and controls the backlight module to blink in accordance with a first driving frequency during the first frame time.

11. The display device of claim 10, wherein when the image is not a still image, the processing circuit controls the display panel to display the image during a second frame time, and the second frame time is shorter than the first frame time.

12. The display device of claim 10, wherein when the image is not a still image, the processing circuit controls the backlight module to blink in accordance with a second driving frequency during a second frame time or to keep turning on during the second frame time, and the second driving frequency is less than or equal to the first driving frequency.

13. The display device of claim 10, wherein the processing circuit controls the backlight module to blink in accordance with the first driving frequency during a part of the first frame time and then controls the backlight module to keep turning on.

14. The display device of claim 13, wherein the backlight module has a first brightness as the backlight module blinks, and the backlight module has a second brightness as the backlight module keeps turning on.

15. The display device of claim 11, wherein the first frame time corresponds to a first refresh rate being smaller than 60 Hz, and the second frame time corresponds to a second refresh rate being greater than or equal to 60 Hz.

16. The display device of claim 15, wherein the display panel has a plurality of liquid crystal cells, and a polarity change rate of the liquid crystal cells is smaller than or equal to the first refresh rate.

17. The display device of claim 10, wherein the first frame time includes an image writing period and a waiting period, and the image writing period is in front of the waiting period.

18. The display device of claim 17, wherein the backlight module blinks in accordance with the first driving frequency during the image writing period, and keeps turning on during the waiting period until the end of the first frame time.
